(19) United States
(12) Patent Application Publication
(10) Pub. No.: US 2014/0119307 A1
(43) Pub. Date: May 1, 2014

(54) ACCESS METHOD BASED ON CARRIER SENSING IN COMMUNICATION SYSTEM

(71) Applicant: Electronics and Telecommunications Research Institute, Daejeon (KR)

(72) Inventors: Hyun Gu HWANG, Daejeon (KR); Dae Ho KIM, Daejeon (KR)

(73) Assignee: Electronics and Telecommunications Research Institute, Daejeon (KR)

(21) Appl. No.: 14/069,764

(22) Filed: Nov. 1, 2013

(30) Foreign Application Priority Data
Nov. 1, 2012 (KR) 10-2012-0122817

(51) Int. Cl. H04W 74/08

(52) U.S. Cl. CPC H04W 74/0808
USPC 370/329

(57) ABSTRACT

Provided is an access method using carrier sensing in a communication system. A random access method according to an embodiment of the present invention includes performing sensing with respect to a carrier in a first part of a radio slot, and transmitting preemptive occupation signals for the carrier through the carrier in a second part after the first part of the radio slot when the carrier is in a non-occupied state based on the sensing result in the first part. Accordingly, in the random access method according to the present invention, efficient random access may be made possible even when there are access requests from a large number of terminals in a narrow frequency band in a communication system.

### CLAIM FOR PRIORITY

This application claims priority to Korean Patent Application No. 2012-0122817 filed on Nov. 1, 2012 in the Korean Intellectual Property Office (KIPO), the entire contents of which are hereby incorporated by reference.

### BACKGROUND

1. Technical Field

Example embodiments of the present invention relate in general to a method in which a terminal performs random access in a communication system, and more specifically to a method in which a plurality of terminals perform access through carrier sensing.

2. Related Art

In a general communication system, a large number of terminals share a communication channel with other terminals without exclusively occupying the communication channel alone. Thus, a terminal desiring to use the channel tries to access the channel. This is the same in both wired and wireless manners.

As access methods in the wired manner, an ALOHA method, a slotted ALOHA method, a carrier sense multiple access (CSMA) method, a CSMA with collision detection (CSMA/CD) method, a CSMA with collision avoidance (CSMA/CA) method, and the like may be used. The CSMA/CD method is used in IEEE 802.3 standard. Such a multi-access method may be used in both wired and wireless manners.

In the present invention, a multi-access method that can be mainly used in the wireless manner is proposed. Obviously, the present invention may be used in the wired manner.

In the wireless manner, the ALOHA method may be widely used. The ALOHA method is used in the wireless manner in the almost similar method to the wired ALOHA method rather than exactly the same method. That is, random access slots enabling wireless connection are allocated and a large number of terminals arbitrarily attempt to connect to the random access slots.

In this instance, when the large number of terminals transmit access request signals to the same slot, collision may occur, and therefore the terminals should repeatedly attempt to connect to the slot. That is, the terminals attempt to reconnect to the slot. This method may be slightly changed but has been widely used in a large number of wireless communication systems.

Digital wireless communication has been commercially widely used in a wireless local area network (WLAN) or a mobile communication, but resolution digital wireless communication technologies have been recently developed with the development of the mobile communication.

Even in the wireless communication, a random access slot enabling wireless connection is opened, and terminals attempt to connect to the random access slot through competition. This method has a similar basic principle to that of the wired ALOHA method.

Such an ALOHA method is not efficient in both wired and wireless manners. Accordingly, in a wireless communication system such as mobile communication, a competitive random access method similar to the ALOHA method may be used in a procedure to initially register a terminal in a base station, and a method different from the competitive random access method may be used after the terminal is registered in the base station. That is, the base station controls in such a manner that intended access different from competitive random access is performed.

For example, when a terminal succeeds in random access, the terminal is allocated with an inspection slot and ascertains the control of the base station by periodically demodulating the inspection slot. When the base station issues an access instruction, an instruction indicating to which channel a corresponding terminal should be connected is included in the access instruction, and therefore a collision does not occur. That is, in the wireless communication, the terminal is occasionally controlled by the base station while the terminal is kept almost non-connected, and therefore access may be efficiently performed under the control of the base station without any collision. Obviously, this corresponds to a case in which the base station requests access from the terminal.

On the contrary, when the terminal requests access from the base station, the competitive random access method may be inevitably used again. Obviously in most cases, a specific slot to which the terminal is to be connected is allocated, and therefore less competition than that at the time of initial connection may be shown.

However, this remains still the competitive random access method between terminals to which a corresponding access slot is allocated. For example, in a place such as a soccer stadium having an extremely high population density, a call connection is not successfully established in many cases due to extremely many access requests of the terminals. In order to overcome this problem, a service provider may process the access requests and speech quantities of the terminals by moving a temporary vehicle based station.

In recent days, a digital communication demand occurs even on the sea, and corresponding technologies have been rapidly developed accordingly. However, the number of frequency bands currently allocated to maritime communication is significantly small, and the current number of frequency bands appears to be maintained even in the future. That is, in the maritime communication, the significantly small number of frequency bands should be shared and used by a significantly large number of boats. This is a similar case to the above-described case of the soccer stadium. Therefore, in the maritime communication, access requests of terminals are highly likely to collide with one another.

### SUMMARY

Accordingly, example embodiments of the present invention are provided to substantially obviate one or more problems due to limitations and disadvantages of the related art.

Example embodiments of the present invention provide a random access method which may execute access requests while efficiently avoiding a collision between the access requests when there are the access requests from a large number of terminals in a narrow frequency band in a communication system.

In some example embodiments, a random access method of a communication system includes: performing sensing with respect to a carrier in a first part constituted of at least one subslot of a radio slot constituted of a plurality of subslots; and transmitting preemptive occupation signals for the carrier through the carrier in a second part constituted of at least one subslot after the first part of the radio slot when the carrier is in a non-occupied state based on the sensing result in the first part.

Here, the radio slot may be a random access slot.

Also, a third part constituted of at least one subslot for radio frequency (RF) switching from reception to transmission may be present between the first part and the second part. Alternatively, the RF switching from reception and to transmission may be performed at least at a partial section of the subslots included in the first part.

Here, the number of the subslots constituting the first part may be randomly determined. In this case, the number of the subslots constituting the first part may be determined using a random natural number having values of 0 to A (A is a natural number larger than 0), and an occurrence probability of the random natural number may be uniformly distributed in 0 to A.

In addition, the random access method may further include transmitting access request data in a part of subslots of another radio slot after the radio slot or in a part of the subslots of the radio slot when the preemptive occupation signals are transmitted. In this case, the random access method may further include transmitting the preemptive occupation signals until receiving an acknowledgement (ACK) of the access request data after transmitting the access request data, and transmitting and receiving data when the ACK of the access request data is received.

In other example embodiments, a random access method of a communication system includes: performing sensing with respect to a carrier in a first part of a continuous radio slot; and transmitting preemptive occupation signals for the carrier through the carrier in a second part after the first part of the radio slots when the carrier is in a non-occupied state based on the sensing result in the first part.

Here, the radio slot may be a random access slot.

Also, a section for RF switching from reception to transmission may be present between the first part and the second part. Alternatively, the RF switching from reception and to transmission may be performed at least at a partial section of the first part.

Here, a section length of the first part may be randomly determined. In this case, the section length of the first part may be determined using a random real number having values of 0 to A (A is a real number larger than 0), and an occurrence probability of the random real number may be uniformly distributed in 0 to A.

In addition, the random access method may further include transmitting access request data in a partial section of another radio slot after the radio slot or in a partial section of the radio slot when the preemptive occupation signals are transmitted. In this case, the random access method may further include transmitting the preemptive occupation signals until receiving an ACK of the access request data after transmitting the access request data, and transmitting and receiving data when the ACK of the access request data is received.

### BRIEF DESCRIPTION OF DRAWINGS

Example embodiments of the present invention will become more apparent by describing in detail example embodiments of the present invention with reference to the accompanying drawings, in which:

FIGS. 1A, 1B, and 1C are slot structural diagrams illustrating data slot and random access slot structures for a general random access method;

FIGS. 2A and 2B are slot structural diagrams illustrating data slot and random access slot structures for a random access method according to an embodiment of the present invention;

FIGS. 3A and 3B are slot structural diagrams illustrating two examples of a preemptive occupation slot structure according to an embodiment of the present invention;

FIGS. 4A, 4B, and 4C are slot structural diagrams illustrating a method of transmitting carrier sensing and preemptive occupation signals in a preemptive occupation slot structure constituted of subslots according to an embodiment of the present invention;

FIGS. 5A and 5B are slot structural diagrams illustrating a method of transmitting carrier sensing and preemptive occupation signals in a continuous preemptive occupation slot structure according to an embodiment of the present invention;

FIGS. 6A and 6B are slot structural diagrams illustrating a slot structure including open slots according to an embodiment of the present invention;

FIG. 7 is a slot structural diagram illustrating an example of a random access method in a slot structure including open slots according to an embodiment of the present invention;

FIG. 8 is a slot structural diagram illustrating another example of a random access method in a slot structure including open slots according to an embodiment of the present invention; and

FIGS. 9A and 9B are slot structural diagrams illustrating an example in which a preemptive occupation slot and an access data slot are flexibly utilized in a random access method according to an embodiment of the present invention.

### DESCRIPTION OF EXAMPLE EMBODIMENTS

Example embodiments of the present invention are disclosed herein. However, specific structural and functional details disclosed herein are merely representative for purposes of describing example embodiments of the present invention, and thus example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of examples in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred embodiments of the present invention will be described in detail with reference to the accompanying drawings. In the drawings and description, elements that appear in more than one drawing and/or elements that are mentioned in more than one place in the description are always denoted by the same respective reference numerals and are not described in detail more than once.

In a wireless communication system, a large number of terminals request access in a narrow bandwidth. When a general random access method is used, the terminals transmit their own access request data in access slots.

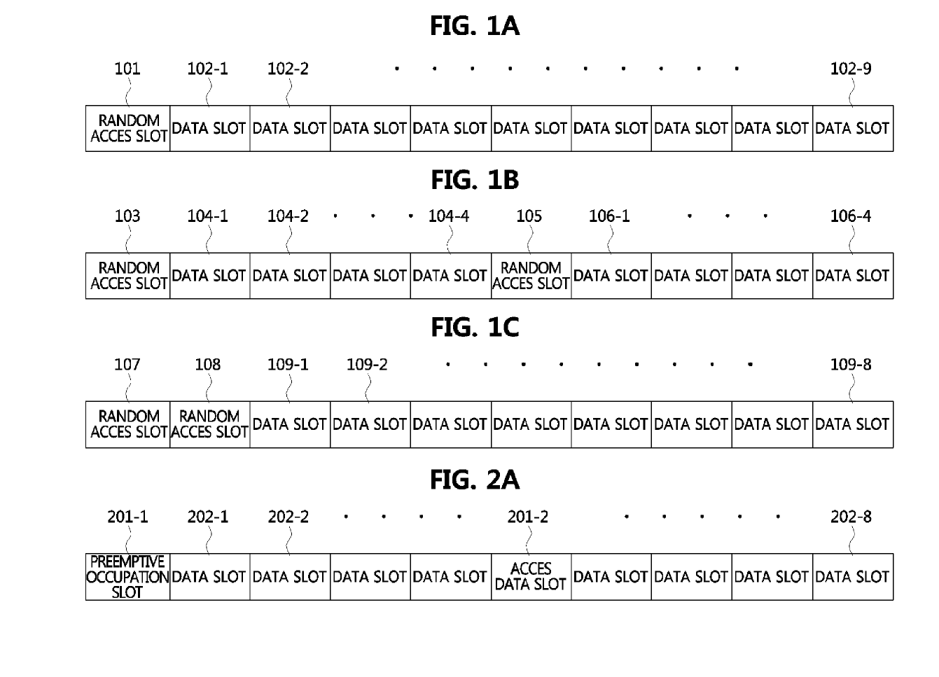

FIGS. 1A to 1C are slot structural diagrams illustrating data slot and random access slot structures for a general random access method.

That is, in FIGS. 1A to 1C, a configuration of a single period of radio slots is shown. Referring to FIG. 1, random access slots 101, 103, and 105 may be allocated one by one for each several data slots 102-1, 102-2, . . . , 102-9, 104-1, . . . , 104-4, 106-1, . . . , 106-4 as shown in FIGS. 1A and 1B, or at least two random access slots 107 and 108 may be continuously allocated as shown in FIG. 1C.

In any case, when two or more terminals transmit access request data to a single random access slot, a collision may occur.

Obviously, when the collision occurs, the access request data may be transmitted again later. A small number of terminals may succeed in access in a predetermined time (so-called back-off time) despite the occurrence of collision. However, even though a large number of terminals request access again using an appropriate algorithm in a predetermined time after the occurrence of collision, a collision may repeatedly occur. That is, since the large number of terminals repeatedly collide with one another and repeatedly request the access, the terminals hardly succeed in the access.

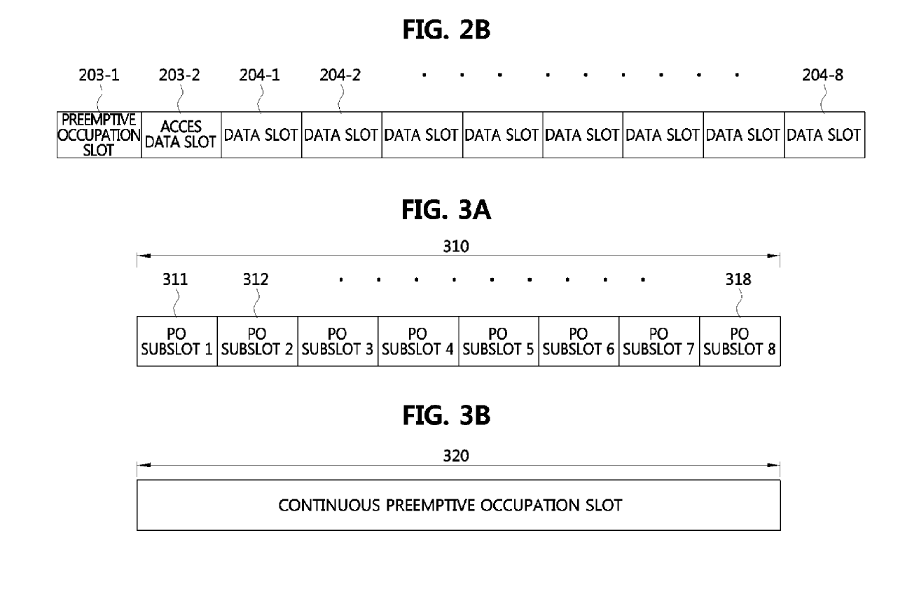

FIGS. 2A and 2B are slot structural diagrams illustrating data slot and random access slot structures for a random access method according to an embodiment of the present invention.

That is, in FIGS. 2A and 2B, a configuration of a single period of radio slots is shown as shown in FIG. 1. Referring to FIG. 2, in the present invention, random access slots are divided into two kinds. One kind is a preemptive occupation slot 201-1 or 203-1, and the other kind is an access data slot 201-2 or 203-2.

In this instance, the preemptive occupation slot and the access data slot may be separated from each other by a predetermined number of slots rather than continuously provided as shown in FIG. 2A, or may be continuously provided as shown in FIG. 2B.

First, the preemptive occupation slot is a slot that enables a corresponding terminal to have an access authority first by transmitting only preemptive occupation signals without transmitting access request data. The preemptive occupation signals enable other terminals to recognize that a corresponding slot is occupied through carrier sensing. As the preemptive occupation signals, simple NULL data signals, random data signals, or the like may be used.

Next, the access data slot is a slot for transmitting access request data of a corresponding terminal. The access data slot corresponds to an existing random access slot.

Processing one-time access request using two access slots is inefficient in some ways. That is, in a case in which a collision hardly occurs due to a small number of terminals, it is efficient to use only one access slot. However, in a case in which a lot of collisions occur, it is more efficient to use the two access slots.

In the preemptive occupation slot, a terminal performs carrier sensing to determine whether other terminals transmit preemptive occupation signals, and transmits the preemptive occupation signals only when the other terminals do not transmit the preemptive occupation signals based on the determination result, and therefore most collisions can be avoided. In other words, in an existing random access method, a plurality of terminals simultaneously attempt to connect to a single access slot to cause a collision therebetween.

On the other hand, in the random access method according to the present invention, a corresponding terminal performs carrier sensing before a plurality of terminals simultaneously transmit access request data, and attempts access only when data signals or preemptive occupation signals are not transmitted from other terminals, and therefore a collision hardly occurs.

A structure of a preemptive occupation slot and an operating method of a terminal in the preemptive occupation slot will be described herein in further detail.

FIGS. 3A and 3B are slot structural diagrams illustrating two examples of a preemptive occupation slot structure according to an embodiment of the present invention.

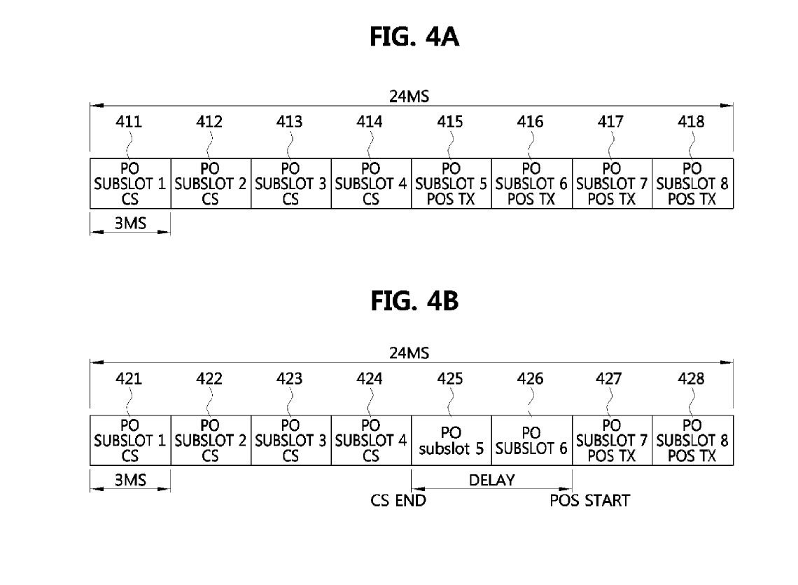

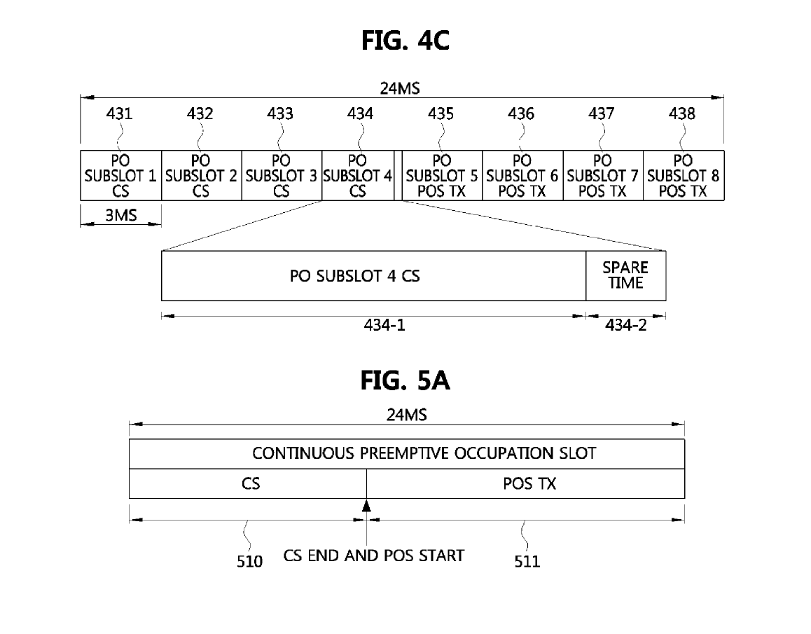

As an example, referring to FIG. 3A, a preemptive occupation slot 310 according to an embodiment of the present invention may be divided into a plurality of subslots 311 to 318. In a structure of a random access slot shown in FIG. 3A, a terminal performs carrier sensing in units of the subslots, and transmits a preemptive occupation signal when it is determined that a slot is empty. Specific subslot unit operations of this case will be described with reference to FIGS. 4A to 4C.

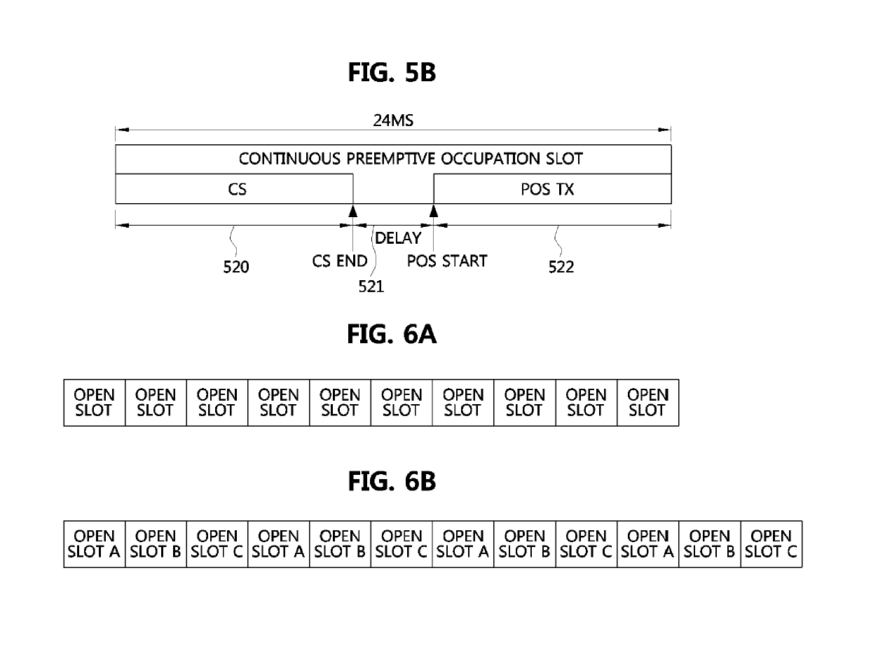

As another example, referring to FIG. 3B, the preemptive occupation slot according to an embodiment of the present invention may include a single continuous slot 320 (that is, continuous preemptive occupation slot). In the structure of a random access slot shown in FIG. 3B, a terminal continuously performs carrier sensing for a predetermined time period, and transmits a preemptive occupation signal when it is determined that a slot is empty. Specific slot unit operations of this case will be described with reference to FIG. 5.

FIGS. 4A, 4B, and 4C are slot structural diagrams illustrating a method of transmitting carrier sensing and preemptive occupation signals in a preemptive occupation slot structure constituted of subslots according to an embodiment of the present invention.

Referring to FIGS. 4A to 4C, a method in which a terminal transmits carrier sensing and preemptive occupation signals when a random access slot (having a length of 24 ms) is constituted of eight sub slots (each having a length of 3 ms) is illustrated. However, the number and length of the subslots constituting the random access slot may be configured in various ways.

First, in FIG. 4A, a terminal performs carrier sensing for a period of time corresponding to front four subslots 411 to 414, and transmits preemptive occupation signals for a period of time corresponding to back four subslots 415 to 418 when it is determined that a slot is empty (that is, when it is determined that other terminals do not occupy a carrier).

On the other hand, in FIG. 4B, a terminal performs carrier sensing for a period of time corresponding to front four subslots 421 to 424, delays a preemptive occupation signal by a period of time corresponding to two subslots 425 and 426 when it is determined that a slot is empty (that is, when it is determined that other terminals do not occupy a carrier), and then transmits the preemptive occupation signal for a period of time corresponding to the final two subslots 427 and 428.

The structure shown in FIG. 4A is the most desirable case, but for this, a corresponding terminal should transmit and receive signals in the same frequency, and therefore radio frequency (RF) transmitter and receiver become complex.

Accordingly, as shown in FIG. 4B, a terminal performs carrier sensing for a period of time corresponding to the four subslots 421 to 424, switches an RF configuration of the terminal from reception (Rx) to transmission (Tx) (Rx to Tx transition) while waiting for a period of time corresponding to the two subslots 425 and 426, and then transmits a preemptive occupation signal for a period of time corresponding to the remaining two subslots 427 and 428. Thus, a terminal RF is not required to be simultaneously transmitted and received in the same frequency.

On the other hand, a structure of FIG. 4C may also be possible. When a switching time from Rx to Tx is significantly shorter than a single slot time in accordance with a configuration of an RF unit of a terminal, a terminal does not need to consume at least one subslot interval for the purpose of Rx to Tx switching.

Accordingly, the terminal completes carrier sensing 434-1 more quickly in the final subslot 434 in which the carrier sensing is performed to ensure a little extra time 434-2. The extra time ensured in this manner may be used to switch from Rx to Tx, determine the carrier sensing result, or preparing a Tx signal.

Suppose that a preemptive occupation slot is constituted of N subslots. N is an integer number greater than 1. Carrier sensing is performed from a first subslot to an A-th subslot. A is an integer greater than or equal to 0 and less than N. Here, A is 0 refers to a terminal unconditionally transmitting a preemptive occupation signal without carrier sensing. There are many methods of determining A, but as the most efficient method, integers from 0 to N−1 may be randomly selected at the same selection probability. In this manner, transmission times of a plurality of terminals transmitting preemptive occupation signals may be uniformly distributed across a single slot.

FIGS. 5A and 5B are slot structural diagrams illustrating a method of transmitting carrier sensing and preemptive occupation signals in a continuous preemptive occupation slot structure according to an embodiment of the present invention.

Referring to FIGS. 5A and 5B, a method in which a terminal transmits carrier sensing and preemptive occupation signals in a continuous slot structure is shown.

First, in FIG. 5A, a terminal performs carrier sensing within a random access slot interval (for example, 24 ms) for a predetermined time MO, and transmits a preemptive occupation signal for a period of time corresponding to the remaining slot 511 when it is determined that a slot is empty.

On the other hand, in FIG. 5B, a terminal performs carrier sensing for a period of time 520, delays a preemptive occupation signal by a predetermined delay time 521 when it is determined that a slot is empty, and then transmits the preemptive occupation signal for a period of time corresponding to the remaining slot 522.

FIG. 5A is the most desirable and ideal case. However, for this, a corresponding terminal should transmit and receive signals in the same frequency as described above. Accordingly, as shown in FIG. 5B, a terminal performs carrier sensing for a predetermined period of time, switches an RF configuration of the terminal from Rx to Tx for a predetermined delay time, and then transmits a preemptive occupation signal for a period of time corresponding to the remaining slot. Thus, a terminal RF is not required to be simultaneously transmitted and received in the same frequency.

Suppose that a preemptive occupation slot is constituted of a continuous T time. Carrier sensing is performed from a start of a slot to an A time. Here, A is a real number greater than or equal to 0 and less than T. A case of A is 0 refers to a terminal unconditionally transmitting a preemptive occupation signal without carrier sensing. There are many methods of determining A, but as the most efficient method, real numbers greater than or equal to 0 and less than T may be randomly selected at the same selection probability. In this manner, transmission times of a plurality of terminals transmitting preemptive occupation signals may be uniformly distributed across a single slot.

In order to avoid a collision, in both the two structures of the preemptive occupation slot, it is important that completion times of carrier sensing are uniformly distributed across a preemptive occupation slot time. When two terminals perform carrier sensing at the same or almost the same time intervals, the two terminals determine that a slot is not occupied and transmit preemptive occupation signals, and therefore a collision may occur. Through the structure of the slot and access method according to the present invention, a collision can be significantly effectively avoided. A collision inevitably occurs in the existing method even though the number of terminals attempting access is only two, but in the present invention, a collision can be avoided even though a large number of terminals simultaneously attempt access. This is because, in an ideal case, a collision may occur only when terminals stop carrier sensing in the same subslot.

For example, in a case in which a preemptive occupation slot is divided into eight subslots as shown in FIG. 4A, a collision probability is ideally 12.5% (=1−⅞) when two terminals simultaneously attempt access. When three terminals simultaneously attempt access, a collision probability is 23.4% (=1−((⅞)×(⅞))). Furthermore, even when the number of terminals simultaneously attempting access is 10 which is greater than 8 that is the number of subslots, a collision probability is 73.7% which is less than 100%.

In an ideal case, when a preemptive occupation slot is divided into N subslots, the number of terminals simultaneously attempting access to the slot is M, and M terminals perform carrier sensing up to subslots obtained by randomly selecting integers from 0 to N−1 at the same probability, a collision probability Pc is the same as the following Equation 1.

Pc=1−((N−1)/N)M [Equation 1]

As can be seen from Equation 1, a collision probability is significantly reduced along with an increase in N. In addition, since a collision probability is always smaller than 1 no matter how large M is, a system is not down.

When a terminal attempts access to a slot, the following procedures are the same as general procedures. For example, when correctively receiving an access request signal of a corresponding terminal, a base station transmits an acknowledge (ACK) and control data to the corresponding terminal through a fixed channel and slot, and the corresponding terminal receives the ACL and control data and then transmits and receives data to and from the base station in accordance with a received control instruction. When not correctly receiving the access request signal of the terminal, the base station cannot transmit an ACK, and the terminal attempts access again. Alternatively, when the terminal does not correctively receive an ACK even though the base station transmits the ACK, the terminal attempts the access again.

As above, on the assumption of a case in which random access slots and data slots are separated to constitute radio slots of a single period in a communication system, the present invention has been described with reference to FIGS. 3A to 5B.

However, in case of the communication system, a configuration in which an access slot for access is not separately allocated may be possible. That is, a configuration in which application of a single slot is not limited to a random access slot or a data slot may be possible. Such slots may be referred to as open slots.

FIGS. 6A and 6B are slot structural diagrams illustrating a slot structure including open slots according to an embodiment of the present invention.

In FIGS. 6A and 6B, a configuration of radio slots of a single period is exemplarily illustrated. Referring to FIG. 6A, a terminal may always attempt access in any slot, and transmit and receive data in any slot. In addition, as another example, referring to FIG. 6B, a terminal may select slot types A, B, and C and always attempt access in the selected types of slots.

First, an operation method in a slot structure shown in FIG. 6A will be described. In this structure, all slots may be used as data slots or random access slots.

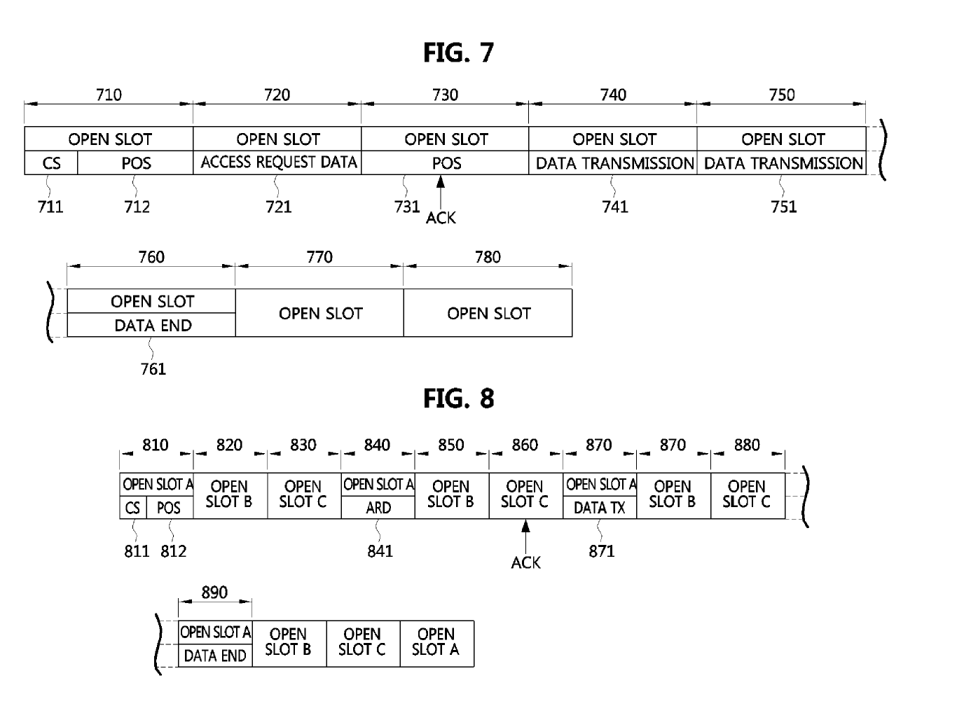

FIG. 7 is a slot structural diagram illustrating an example of a random access method in a slot structure including open slots according to an embodiment of the present invention.

Referring to FIG. 7, a terminal attempting access performs carrier sensing in a carrier sensing section 711 of a radio slot 710. When the radio slot is used by another terminal, the terminal that has performed carrier sensing determines that the slot is occupied based on the carrier sensing result, and does not transmit a preemptive occupation signal. Thereafter, when it is determined that the slot is empty based on the carrier sensing result, the terminal transmits a preemptive occupation signal in a preemptive occupation signal section 712, and transmits access request data 721 in the following slot 720. Next, the terminal waits until receiving a required ACK.

Here, since the ACK cannot be received through the same channel, the ACK should be transmitted through another channel. In this instance, the terminal occupies the channel by continuously transmitting the preemptive occupation signal for occupying a channel up to a slot in which the ACK is received.

For example, when it is assumed that an ACK 732 is received in the following slot 730 immediately after the access request data is transmitted as shown in FIG. 7, the terminal continuously transmit a preemptive occupation signal 731 even in the slot in which the ACK 732 is received. Next, when the ACK is not detected, the terminal returns to the procedure to attempt access by performing carrier sensing again.

When the ACK is detected, the terminal proceeds to the procedure to transmit data. For example, when data to be transmitted no longer exist while the terminal transmits data 741 and 751 in the radio slots 740 to 760, the terminal stops the transmission of data 761. Then, the slot is empty, and other terminals may attempt access.

Next, an operation method in a slot structure shown in FIG. 6B will be described. In this structure, only types of slots associated with the terminal may be used as data slots or access slots.

FIG. 8 is a slot structural diagram illustrating another example of a random access method in a slot structure including open slots according to an embodiment of the present invention.

Referring to FIG. 8, a terminal that attempts access performs carrier sensing in a carrier sensing section 811 of a designated type of radio slot (for example, A type of radio slot 810). When another terminal is using the slot, the terminal attempting access determines that the slot is occupied based on the carrier sensing result, and performs carrier sensing in the following A type of radio slot again.

When it is determined that the slot is not occupied due to an empty slot based on the carrier sensing result, the corresponding terminal transmits a preemptive occupation signal in a preemptive occupation signal transmission section 812, and transmits access request data (ARD) 841 in the following A type of slot 840. Next, the terminal waits until receiving a required ACK.

Here, there is a difference with the slot structure shown in FIG. 6A in that the ACK can be received through different channels or even through the same channel in the slot structure shown in FIG. 6B.

For example, as shown in FIG. 8, the ACK may be received in a C type of slot 860 of the same channel. Obviously in this case, the C type of slot 860 may be mainly used for control rather than data transmission. For example, as shown in FIG. 8, it is assumed that the ACK is received in the following C type of slot immediately after transmitting access request data. Here, when the ACK is not detected in the C slot, the terminal returns to the procedure to attempt access by performing carrier sensing again, and when the ACK is detected, the terminal proceeds to the procedure to transmit data.

When data to be transmitted no longer exist while terminal transmits data in a corresponding A type of slot 870, the terminal stops the transmission of data. Then, the A type of slot is empty, and other terminals may attempt access even in the A type of slot. This process is shown in FIG. 8.

Finally, in order to maximize utilization of the present invention, flexible utilization of preemptive occupation slots and access data slots will be described.

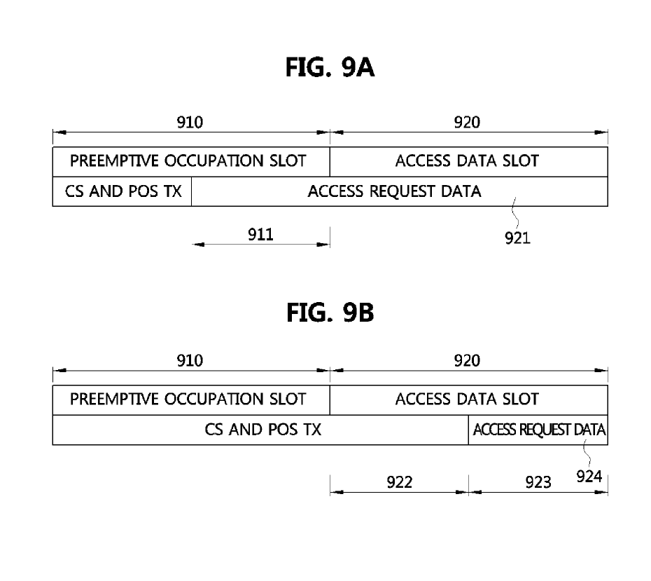

FIGS. 9A and 9B are slot structural diagrams illustrating an example in which a preemptive occupation slot and an access data slot are flexibly utilized in a random access method according to an embodiment of the present invention.

In FIGS. 9A and 9B, a length of access request data may be short or long depending on a system. When the length of the access request data is long, a part of a rear section of a preemptive occupation slot may be utilized to transmit a part of the access request data, and the remaining parts of the access request data may be allocated to an access data slot. FIG. 9A is used to describe this, and in FIG. 9A, an example in which a partial section 911 of the preemptive occupation slot 910 is used to transmit access request data 921 together with an access data slot 920 is shown.

On the other hand, when the length of the access request data is short, a part 922 of a front section of the access data slot 920 may be used for preemptive occupation, and access request data 924 may be transmitted during the remaining section 923. This is shown in FIG. 9B.

Therefore, the present invention may be more flexibly applied depending on a condition of a system.

As described above, according to the embodiments of the present invention, the random access method may be used to execute, by terminals, an access request from a base station in a cellular network or an access point in a WLAN.

In addition, in the random access method according to the present invention, efficient random access may be made possible when a large number of terminals efficiently request access, even when there are access requests from a large number of terminals in a narrow frequency band in a communication system.

While the example embodiments of the present invention and their advantages have been described in detail, it should be understood that various changes, substitutions, and alterations may be made herein without departing from the scope of the invention.

What is claimed is:

1. A random access method of a communication system, comprising:
performing sensing with respect to a carrier in a first part constituted of at least one subslot of a radio slot constituted of a plurality of subslots; and
transmitting preemptive occupation signals for the carrier through the carrier in a second part constituted of at least one subslot after the first part of the radio slot when the carrier is in a non-occupied state based on the sensing result in the first part.

2. The random access method of claim 1, wherein the radio slot is a random access slot.

3. The random access method of claim 1, wherein a third part constituted of at least one subslot for RF switching from reception to transmission is present between the first part and the second part.

4. The random access method of claim 1, wherein the RF switching from reception and to transmission is performed at least at a partial section of the subslots included in the first part.

5. The random access method of claim 1, wherein the number of the subslots constituting the first part is randomly determined.

6. The random access method of claim 5, wherein the number of the subslots constituting the first part is determined using a random natural number having values of 0 to A (A is a natural number larger than 0), and an occurrence probability of the random natural number is uniformly distributed in 0 to A.

7. The random access method of claim 1, further comprising:
transmitting access request data in a part of subslots of another radio slot after the radio slot or in a part of the subslot of the radio slot when the preemptive occupation signals are transmitted.

8. The random access method of claim 7, further comprising:
transmitting the preemptive occupation signals until receiving an acknowledge (ACK) of the access request data after transmitting the access request data, and transmitting and receiving data when the ACK of the access request data is received.

9. A random access method of a communication system, comprising:
performing sensing with respect to a carrier in a first part of a continuous radio slot; and
transmitting preemptive occupation signals for the carrier through the carrier in a second part after the first part of the radio slots when the carrier is in a non-occupied state based on the sensing result in the first part.

10. The random access method of claim 9, wherein the radio slot is a random access slot.

11. The random access method of claim 9, wherein a section for RF switching from reception to transmission is present between the first part and the second part.

12. The random access method of claim 9, wherein the RF switching from reception and to transmission is performed at least at a partial section of the first part.

13. The random access method of claim 9, wherein a section length of the first part is randomly determined.

14. The random access method of claim 13, wherein the section length of the first part is determined using a random real number having values of 0 to A (A is a real number larger than 0), and an occurrence probability of the random real number is uniformly distributed in 0 to A.

15. The random access method of claim 9, further comprising:
transmitting access request data in a partial section of another radio slot after the radio slot or in a partial section of the radio slot when the preemptive occupation signals are transmitted.

16. The random access method of claim 15, wherein
transmitting the preemptive occupation signals until receiving an ACK of the access request data after transmitting the access request data, and transmitting and receiving data when the ACK of the access request data is received.
